(19) United States
(12) Patent Application Publication
(10) Pub. No.: US 2003/0105741 A1
(43) Pub. Date: Jun. 5, 2003

(54) Method for the management of a main document

(76) Inventor: Nicolas Bouthors, Meylan (FR)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 10/302,881

(22) Filed: Nov. 22, 2002

(30) Foreign Application Priority Data
Nov. 22, 2001 (FR) FR 01 15146

(51) Int. Cl. G06F 7/00

(52) U.S. Cl. 707/1

(57) ABSTRACT

A main document 201 is structured into two parts, a source part (203) comprising unprocessed information and a structuring part (204). The structuring part comprises several sub-parts (G1, G2, . . . GN), called grammatical parts. Each grammatical part corresponds to a level of depth of the source part. A user accessing the main document may choose one or more grammatical parts to be added to the source document. The grammatical parts are either applied at the same time to display the main document to which all these chosen grammatical parts have been added simultaneously or applied so as to produce several secondary documents, each of these secondary documents corresponding to one or more chosen grammatical parts.

An object of the present invention is a method for the management of a main document. The field of the invention is that of systems for the management of documents and of screens to display these documents. The field of the invention is therefore especially but not solely that of e-books. The field of the invention is more generally that of systems used to produce an image corresponding to a piece of information that the user of the system wishes to view. It is an aim of the invention to enhance the value of one and the same source document by presenting it in numerous ways. Another aim of the invention is to enable the proposing of services related to the consultation of a document, the services being capable of developing in the course of time.

In the prior art, there are known electronic books or e-books. However, the solutions related to the e-book are based on closed approaches, such as for example the CYTALE system. In this system, a document is built according to a grammar known as the XML (eXtended Markup Language) grammar which is a unique grammar. Only one application can manage this grammar at a given time. It is therefore not possible to add to the document outside the framework of the already established grammar. Indeed, a document in the XML format has a syntax defined by a grammar. This grammar is generally named in the header of the XML document. The syntax of the XML document then complies strictly with this grammar. The document itself then integrates the elements of the grammar. Once the document has been written, it is therefore very difficult, and in fact impossible, to have it erased and significantly changed since its evolution is limited by its grammar.

Consequently, e-books are limited in their uses and cannot provide truly and significantly valuable functions as compared with paper books. Furthermore, the functions provided are fixed and unchanging.

In the prior art, the most widespread grammars are known as the DTD (Document Type Definition) grammars. A grammar specifies the way in which the document is structured. Generic programs of lexical analysis can then ascertain that the document complies with the grammar and thus prevent many errors induced by poor syntax in the document.

Thus, a document in the XML format has a certain number of “tags” added to it. These tags are used to structure the document and, if necessary, to convert it later through applications. A grammar then defines the syntax structure and the nature of the information to be found between tags which themselves are also defined by the grammar so that the document complies with this grammar.

In the prior art, a file in the XML format can also refer to another file known as a stylesheet, used to format the XML document. This file is specified in the XSL or eXtensible Stylesheet Language. This language defines what are called stylesheets. A stylesheet defines a presentation of data registered in an XML format. This document architecture makes it possible to clearly separate the formatting commands from the data structuring information itself. Thus, a prior art XML format document comprises a header containing information on grammar and information on style, as well as the body of the document comprising the data structured by using the syntax defined by the grammar.

Thus, with this model, a high level of flexibility is obtained. However, only one grammar and, at a given point in time, only one application or stylesheet, can be associated with a document. Indeed, in the standard XML model, the document, and the data itself, are structured through the grammar. The grammar and data are therefore indissociable. The problems appear with the variety of possibilities that the user, accessing the data contained in the document, would like to obtain. Indeed, the user may wish to access the document at high speed, analytically, with annotations from a variety of sources, with internal or external references, each of these modes of access being liable to be made more ample by various textual and other contributions. In the prior art, it is impossible to meet these requirements. Indeed, the documents in the existing XML format are permanently fixed and do not allow for any real change, unless a new XML document is entirely recreated. This implies, inter alia, the duplication of the formation of the document, which represents a major drawback in terms of maintenance and referential integrity.

The invention resolves these problems by managing a document through a specific XML syntax. A document according to the invention thus comprises mainly two parts, a structuring part and a part comprising the data to be structured. The structuring part then comprises information to structure the data according to several grammars and to associate them with different applications. These numerous associations of the data with a variety of grammars makes it possible to obtain a multiplicity of views capable of meeting all the requirements of a person accessing the data.

Starting from a document according to the invention, it is therefore possible to produce a document with a standard XML format, namely a document that contains structured data that can undergo a page layout by means of a stylesheet for example. A document according to the invention can be used to produce several secondary documents in a standard format, each of the secondary documents corresponding to a wish on the part of the person consulting the data recorded in the document. A document according to the invention also enables the application of several grammars to data, making it possible to modulate the level of enrichment of the data.

With the invention, it also becomes possible to add elements to the structuring part or remove elements from it without altering or having to alter the data part. With the invention, it is also possible to modify a part of the structuring part without altering the rest of the structuring part.

The invention therefore makes it possible to resolve the problems of the prior art with great flexibility.

An object of the invention is a method for the management of a main document in which the main document comprises means to structure said main document into distinct parts, characterised in that the main document is structured into at least two parts:

a part known as a source document, comprising data of interest to a person accessing the main document,

a structuring part comprising several grammatical parts, each corresponding to a grammar and each corresponding to a structure for the source document, to structure the source document according to each grammar.

The invention will be understood more clearly from the following description and from the accompanying figures. These figures are given purely by way of an indication and in no way restrict the scope of the invention. Of these figures:

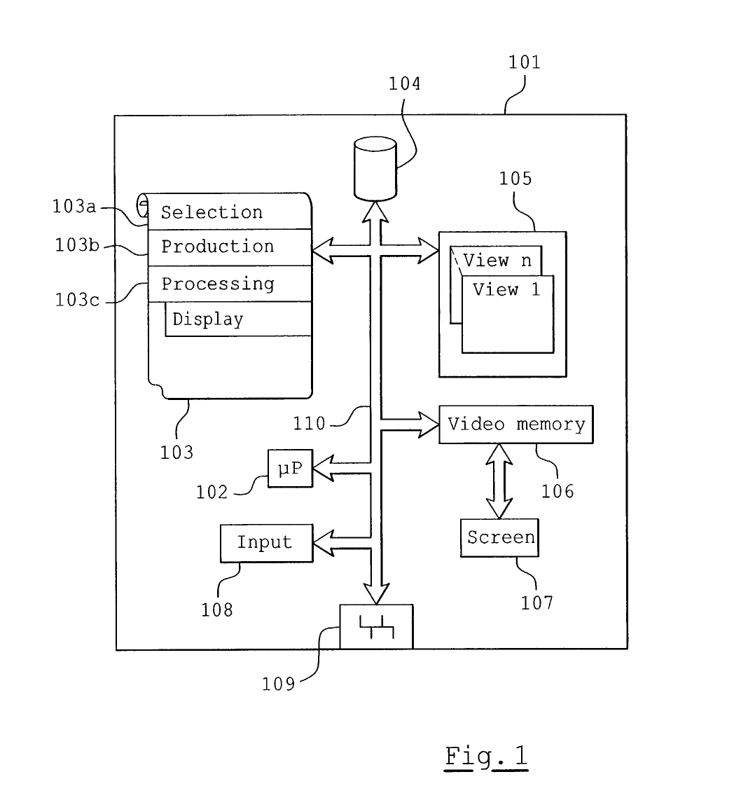

FIG. 1 illustrates means useful for the implementation of the invention.

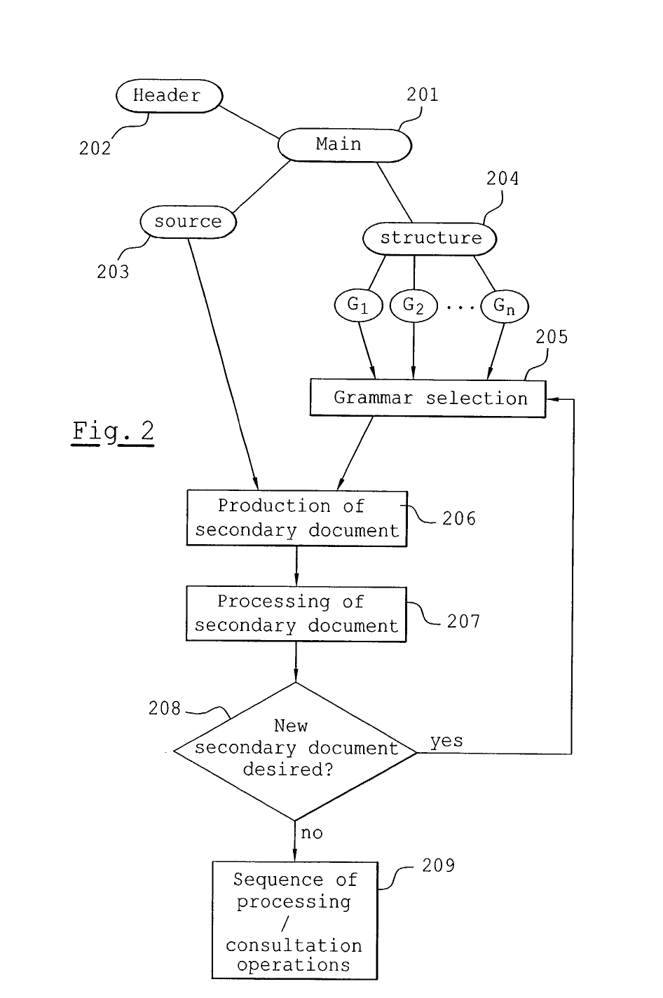

FIG. 2 illustrates the structure of a document according to the invention and its implementation by steps of the method according to the invention.

FIG. 1 shows a device 101 which is, for example, an electronic book or e-book. The device 101 comprises a microprocessor 102 capable of executing instruction codes recorded in a program memory 103. The memory 103 is divided into several zones. Each zone comprises instruction codes performing a function. Only zones that are more specifically relevant to the invention shall be referred to herein. As a general rule, when an action is attributed to the microprocessor 102 of the device 101, this action is performed through the execution, by the microprocessor 102, of instruction codes recorded in a zone of the memory 103.

The memory 103 comprises a zone 103a corresponding to a selection and/or activation of the grammar in a document according to the invention.

A zone 103b corresponds to the production of a secondary document from a selected grammar and from data recorded in the document according to the invention.

A zone 103c corresponds to processing operations that can be performed on a secondary document. These processing operations pertain, for example, to a display operation.

The device 101 also has a memory or disk 104 called a storage memory. The memory 104 can be used to record documents in a format according to the invention. These documents are in fact recorded in the form of a file.

The device 101 comprises a memory 105 in which secondary documents produced by the microprocessor 102 are recorded.

The device 101 has a video memory 106 to which the microprocessor 102 writes an image that must be displayed on a screen 107 interfaced with the video memory 106. The screen 107 is either internal to the device 101 or connected to the device 101 by means of circuitry that is not shown. In practice, this circuitry converts the contents of the memory 106 into signals that can be displayed by a screen.

The device 101 also has input peripherals 108. A peripheral of this kind is, for example, a mouse or a trackball. The device 101 also has circuits 109 to get connected to a network, for example the Internet. The elements 102 to 106,108 and 109 are connected through a bus 110. It may be recalled that a bus is a set of wires or tracks comprising a number of these elements sufficient to convey control, address, data, interruption, clock and supply signals. It may also be recalled that, although the memories 103 to 106 have been shown in an exploded view, they may actually coexist in a unified memory. The representation of these memories is not restricted as regards their implantation.

FIG. 2 shows a document 201 according to the invention. A document of this kind is also called a main document or multidocument. According to the invention, a document of this kind is divided into at least two parts. In a preferred mode of implementation, a document of this kind is in an XML format. The XML standard is defined by a recommendation of the W3C or World Wide Web Consortium, dated Feb. 10, 1998. This recommendation, known as XML1.0, is available at the W3C Internet site www.w3c.org/xml.

The document 201 comprises a header 202. Such a header corresponds, for example, to the first three lines of the example given below. Hereinafter, the references made to lines refer to the lines of the example below.

XML file according to the invention:

```
01 <?xml version= “1.0” ?>
  <?xml-stylesheet type=“text/xsl” href=“build.xsl”>
  <!DOCTYPE metabook SYSTEM=“metabook.dtd”>
  <MULTIDOC>
05 <GRAMMARS>
      <OBJECT>
        <TITLE>presentation</TITLE>
        <CATEGORY>display</CATEGORY>
        <DTD>thisbook.dtd</DTD>
          <APP>thisbook.xsl</APP>
        <CARD>thisbook.map</CARD>
      </OBJECT>
      <ONJECT>
        <TITLE>index</TITLE>
          <CATEGORY>indextable</CATEGORY>
        <DTD>thisbook_index_dtd</DTD>
        <CARD>thisbook_index.map</DTD>
      </OBJECT>
      <OBJECT>
          <TITRE>speedread</TITRE>
        <CATEGORY>speed</CATEGORY>
        <DTD>thisbook_speed.dtd</DTD>
        <CARD>thisbook_speed.map</CARD>
      </OBJECT>
      </GRAMMARS>
    <BASEDOC>bla bla bla</BASEDOC>
</MULTIDOC>
```

Line 1 indicates which version of the XML standard is used to write the document. Line 2 indicates which stylesheet can be used to display the contents of the document and line 3 indicates the grammar governing the syntax of the document. The syntax of the three lines is defined by the W3C standard. Line 2 of the exemplary XML file shows that the stylesheet is in the XSL format. There are other standards for the stylesheet, for example CSS (Cascaded Style Sheet), which can also be used by the invention. The XSL format for its part is also defined by the W3C to represent the data of the XML document. The first three lines of the exemplary XML file therefore signify that the document according to the invention has been drawn up according to a set of formal rules corresponding to the version 1.0 of the XML standard, that the stylesheet which may be used to represent the data contained in the exemplary file is called “build.xsl”, and that the syntax of the document contained in the exemplary file must comply with the grammar recorded in the file named “metabook. dtd”. The file names used for the description are arbitrary and it is only their contents that count. This is also true for all the file names referred to in the description.

The invention is not affected by the presence or absence of these first three lines. These first three lines are useful but not necessary in the context of an implementation of the invention using a set of formal XML rules.

The main document 201 comprises a source part 203. This part is also called a source document or basic document. In the exemplary XML file, this part corresponds actually to the line 26 of the example. The source document part 203 is demarcated by two tags: one is the opening tag <BASEDOC> while the other is the closing tag </BASEDOC>. This corresponds to the formal XML rules which encapsulate the data, and the structures, by using start and end tags for each part. An end tag preferably bears the same name as the start tag preceded by a “/”. A tag using the XML format is demarcated by the signs < and >. Other notational conventions, namely conventions different from those used in the XML recommendation, may be used to demarcate the parts without thereby affecting the invention.

The information contained between <BASEDOC> and </BASEDOC> corresponds to the data that the person accessing the main document 201 wishes to access. Between the two above-mentioned tags, the information is recorded in a rough state, namely in the text format without page layout. In a preferred example, this information then contains no tag.

In a preferred variant of the invention, the data is registered in its totality between the two tags. In another variant of the invention, between the two tags, there is a reference to an external file containing the data.

In a preferred way, a reference of this kind takes the form of a URL or Universal Resource Locator. This reference can therefore be used to designate either a file recorded in a memory of the device 101 or a file accessible through the circuits 109, and a network to which the device 101 is connected.

The document 201 also has a structuring part 204. This part too is demarcated by two tags: one is the opening tag and the other is the closing tag. In the example chosen, the opening tag is <GRAMMARS>, and the closing tag is </GRAMMARS>.

In the example chosen, the source document 203 and the structuring part 204 are themselves placed between two tags: one is the opening tag and the other is the closing tag. These tags are <MULTIDOC> and </MULTIDOC>. These tags are not fundamental but their presence makes it possible, if necessary, to record several multidocuments in one in the same file using the format according to the invention. This means that it is possible, after the </MULTIDOC> tag, to record another structure corresponding to the structure of the document according to the invention but having source and structuring parts different from the first multidocument.

The structuring part 204 too is divided into several parts known as grammatical parts. The grammatical parts are identified from G1 to GN. Each of these grammatical parts is recorded between an opening tag and a closing tag. In the present example, the tags <OBJECT> and </OBJECT> have been chosen. The exemplary XML file shows a document with three grammatical parts. A grammatical part in turn comprises several fields. Each of these fields has a value and each of these fields is demarcated by an opening tag and a closing tag. Thus, the grammar G1 corresponds to the lines 6 to 12 of the exemplary XML file, the grammar G2 corresponds to the lines 13 to 18 of the same exemplary file and the grammar G3, namely GN, corresponds to the lines 19 to 24 of the example. The description shall be limited here to the structure of the grammatical part G1, since the structure of the other grammatical parts is identical.

The grammatical part G1 comprises, line 9, a reference to a file whose name is “thisbook.dtd”. This reference is included between two tags: one is an opening tag and the other is a closing tag. These tags are <DTD> and </DTD>. Thus, a grammar is associated with this grammatical part. This means that the secondary document that will be produced by means of this grammatical part will have the structure, or syntax, defined by this attached grammar. This also means that the activation of this grammatical part will cause the grammar, attached to this grammatical part, to be implemented on the source document. The reference is of the same nature as the one defined for the source document 203. This is also the case for the nature of any reference to a file hereinafter in the description. In one variant of the invention, the reference may quite simply be the inclusion, in their totality, of the contents of the grammar between the two tags, namely the opening and closing tags, <DTD> and </DTD>.

The grammar G1 also comprises a mapping field recorded between two tags, an opening tag and a closing tag, <MAP> and </MAP>. This corresponds to line 11 of the exemplary XML file. This enables a reference to be made to a file known as “thisbook.map”.

One use of this map file shall be illustrated in the description of the step for the production of the secondary document.

The grammatical part G1 also comprises fields known as TITLE, CATEGORY and APP. These fields define applications capable of implementing a document having a structure compatible with the grammar attached to the grammatical part G1. In particular APP refers to a stylesheet recorded in a file called “thisbook.xsl”. The field TITLE can be likened to a title for the grammatical part. This title enables the user accessing the main document 201 to get a quick idea of the utility of this grammatical part, and of the effects of this implementation. The field CATEGORY is identical to the field TITLE except that it gives another classification key for the grammatical parts. The number of possible fields for a grammatical part is not limited.

When a user accesses a document according to the invention, he starts by choosing a grammatical part. This is the step 205 for the selection of a grammar.

In the part 205, the user is before the device 101 which he has already powered on and, using an interface not described herein, he has selected a file that he wishes to access in the disk 104. This file is in a format according to the invention. The user must therefore decide which mode, namely which grammatical part, he wishes to implement in order to access this file. The microprocessor 102 then goes through the structuring part 204 of the file selected by the user. It then notes that this is a file in the XML version 1.0 format complying with a grammar referenced in line 3 of the exemplary XML file, and that it can be presented by using the stylesheet referenced in line 2 of the exemplary XML file.

In practice, this means that the microprocessor 102 extracts information from the structuring part 204, informing the user of the applications that he can use to access the data of the source part 203. These applications are presented for example in the form of a list produced by the microprocessor 102 from the structuring part 204. This list is presented to the user so that he can make a choice from it. In the exemplary XML file chosen to illustrate the invention, the user therefore has a choice between the presentation of the entire document, namely the grammatical part G1, an index of the document which is the grammatical part G2, and a fast reading of the document, namely the grammatical part G3. The information presented to the user corresponds, for example, to the contents of the TITLE fields of the grammatical parts.

The user of the device 101 uses the input means 108 of the device 101 to select one of the grammatical parts. Let us consider that the user selects the grammatical part G1. The operation then passes to a step 206 for the production of the secondary document.

In the step 206, from the main document 201, the microprocessor 102 extracts the map file corresponding to the grammatical part that has been selected by the user at the step 205. The microprocessor 102 also extracts the source document 203 from the main document. The map file thus extracted comprises information on elements to be inserted into the source document 203 to produce a secondary document corresponding to the user's requirements. These elements are tags corresponding to the grammar attached to the grammatical part selected in the step 205. These elements are also, for example, contributions in the form of text, sound or video. The result of the production, in a preferred example, is a standard XML format file.

The information for the insertion comprises, for example and in addition to the element to be inserted, a piece of information on the location, of the element to be inserted, in the source document 203. In other words, a map file comprises element/location pairs, a location being (for example) a tag, a location being (for example) a number corresponding to a position, expressed as a number of characters, in the source document 203.

The tags introduced thus define attributes for certain parts of the data, for example page layout attributes. These tags introduced also define links to other documents, or to other parts of the secondary document produced. The tags introduced furthermore prompt a reaction on the part of the device 101 during certain actions of the user while he goes through the secondary document produced. Such actions are, for example, a highlighting of a part of the document, a window, known as a POP-UP window, which gets displayed when the user performs an action. These actions are, for example, a click on a certain part of the secondary document or the mere passing of the arrow of a mouse to a part of the secondary document.

In the example chosen, the secondary document produced will therefore be an XML format document whose syntax will be consistent with the grammar defined by the file “thisbook.dtd” and whose display will be done according to the stylesheet recorded in the file named “thisbook.xsl”.

Once produced, the secondary document is recorded in the memory 105. The operation then passes to the step 207 for the processing of the secondary document. In most cases, this means that the display system of the device 101 takes responsibility for the secondary document. In other words, the secondary document is given as an argument to a display program compatible with the syntax of the secondary document. Indeed, the secondary document is what is called a standard XML document, i.e. any e-book whatsoever can take charge of it. An e-book is itself capable of simultaneously displaying several documents. The processing therefore corresponds to the management of this simultaneous display as well as to the events that may occur when the documents are being gone through.

The operation passes to a step 208 in which it is sought to determine if the user wishes to view another document. This step illustrates the fact that, from one and the same main document 201, the user can produce several different secondary documents. These secondary documents will then be recorded in the memory 105 and each of them will be processed as an independent document. The user can therefore simultaneously have two distinct views of the same data of the main document 201.

If the user of the device 101 selects a new document, the operation then goes to the step 205. If not, the operation passes to the step 209 pertaining to a sequence of processing operations or operations of consulting the secondary documents recorded in the memory 105.

In the step 209, the consultation, or any kind of processing, of the secondary document recorded in the memory 105 therefore takes place like any multiple-window application in an office computer.

In practice, the association of an XML document with the stylesheet enables the production of a document in the HTML (hypertext markup language) format that can be displayed in an Internet navigator. Thus, the invention can make use of one and the same main document 201 to produce several secondary documents whose display will actually correspond to the display of several documents in the HTML format. This is only one example and there are other formats that can be introduced from an XML document and an associated stylesheet.

In the invention, the only invariant part of the main document 201 is the source document part 203. The structuring part 204 can be modified according to the requirements of the various services to be provided to the user of the device 101 accessing the main document 201. These modifications are, for example, the addition of a grammatical part, the elimination of a grammatical part or the modification of a grammatical part. This provides for very great flexibility in the management of the contents of the main document 201 and in the presentation of the information that it contains.

In one variant of the invention, in the step 205, the user of the device 101 chooses a certain number of grammatical parts, in practice at least one, that he wishes to activate when accessing the data of the source document 203. In this variant, the grammatical parts are implemented in the context of shared access to the display resource, namely the screen. Indeed, it is necessary for each application, where each one is associated with an activated grammatical part, to be capable of proposing its services. In one example, it is assumed that a user will activate a first grammatical part, enabling the display of the data of the source document 203 with a certain page layout. The user also activates a second grammatical part corresponding to a definition of certain technical words used in the data of the source document 203. The implementation of the first grammatical part enables the user to go through the data of the source document, this data being now page-numbered and formatted. Whenever a page is displayed, namely whenever the display is scrolled, the display application notifies all the activated grammatical parts in order to determine whether, depending on the position of the source document 203 that is displayed, it is necessary to undertake an action as a function of one of the activated grammatical parts. Depending on the map files, and the activated grammatical parts, the planned syntax elements are then implemented, by the activated grammatical parts, for the part of the source document 203 that is displayed. In the present example, the second activated grammatical part then enables the highlighted display of certain expressions. The fact that the user selects a highlighted expression with a pointer device then prompts the display of the definition of the word or expression.

This alternative embodiment enable the application of several grammatical parts to the source document 203, and enables this to be done simultaneously.

Throughout the description, we have used tags which have been named. These tags define parts and/or fields in a document according to the invention. The names of the tags are not important but the parts, and/or fields, defined by them are important. The same result would be obtained by using other names or another syntax for the tags.

As an exemplary application, the description has used stylesheets and their implementations have been used to produce a displayable document. In one variant, the field APP may refer to an executable file capable of interpreting the source document to which at least one grammatical part has been applied.

In one variant of the invention, any reference whatsoever to a file may be expressed by an inclusion of the contents of the file instead of the reference. This actually means that there is no reference but information corresponding to the nature of the field. In other words, and for example between the tags <DTD> and </DTD>, there is then the description of a grammar, and no longer the reference to a file comprising this description.

1—Method for the management of a main document in which the main document comprises means to structure said main document into distinct parts, characterised in that the main document is structured into at least two parts:
a part (203) known as a source document, comprising data of interest to a person accessing the main document,
a structuring part (204) comprising several grammatical parts, each corresponding to a grammar and each corresponding to a structure for the source document, to structure the source document according to each grammar.

2—Method according to claim 1, characterised in that the means to divide the document into distinct parts comprise a part starting tag and a part ending tag.

3—Method according to one of the claims 1 or 2, characterised in that the source document part comprises a reference to a file comprising data of interest to a person accessing the main document.

4—Method according to one of the claims 1 to 3, characterised in that the structuring part comprises several grammatical parts (G1, G2, . . . GN), each corresponding to a grammar and each corresponding to a structure for the source document.

5—Method according to one of the claims 1 to 4, characterised in that a grammatical part comprises a reference to a grammar file comprising the description of a grammar.

6—Method according to one of the claims 1 to 5, characterised in that a grammatical part comprises a reference to at least one application comprising means for the interpretation of the grammar corresponding to said grammatical part.

7—Method according to claim 6, characterised in that the application is a style sheet.

8—Method according to one of the claims 1 to 7, characterised in that a grammatical part comprises a reference to a map file describing the positions of the source document in which the elements corresponding to the grammar of said grammatical part are to be inserted.

9—Method according to claim 8, characterised in that the map file comprises instructions to produce a version of the source document comprising additional data.

10—Method according to one of the claims 8 or 9, characterised in that, from at least one map file referenced in a grammatical part and from at least the source document, a secondary document in a standard description format is produced, this format being preferably the format of the extended Markup Language.

11—Method according to claim 10, characterised in that the secondary document is used (207) as an argument for a display program compatible with the syntax of the secondary document.

12—Method according to one of the claims 3, 5, 6 or 8, characterised in that a reference is of a universal resource locator type.

13—Method according to one of the claims 3, 5, 6, 8, or 12 characterised in that a reference to an element corresponds to the inclusion of this element in its totality.

14—Method according to one of the claims 1 to 13, characterised in that the contents of the structuring part are modified without affecting the main document.

15—Method according to one of the claims 1 to 14, characterised in that the contents of a grammatical part are modified without affecting the other grammatical parts of the structuring part.

16—Method according to one of the claims 1 to 15, characterised in that, during access by a user to the main document:
a list of possible applications for access to the main document is produced (205) from the characterizing part;
the list produced is presented (205) to the user so that he chooses at one possible element of the list,
the main document is presented (206) according to the possibility or possibilities chosen by the user.
